(19) United States
(12) Patent Application Publication
(10) Pub. No.: US 2013/0343635 A1
(43) Pub. Date: Dec. 26, 2013

(54) IMAGE PROCESSING APPARATUS, IMAGE PROCESSING METHOD, AND PROGRAM

(71) Applicant: SONY CORPORATION, Tokyo (JP)

(72) Inventor: Makoto OMATA, Kanagawa (JP)

(73) Assignee: SONY CORPORATION, Tokyo (JP)

(21) Appl. No.: 13/894,728

(22) Filed: May 15, 2013

(30) Foreign Application Priority Data
Jun. 26, 2012 (JP) 2012-143160

(51) Int. Cl. G06T 19/00

(52) U.S. Cl. CPC G06T 19/003
USPC 382/154

(57) ABSTRACT

There is provided an image processing apparatus including an image moving unit that moves viewpoint images according to an instruction from an outside, and changes a parallax amount among a plurality of viewpoint images, an image reading unit that reads the plurality of viewpoint images in units of lines or in units of pixels in a direction perpendicular to a line direction, an image selecting unit that sequentially selects and outputs the plurality of viewpoint images read in units of lines or in units of pixels by the image reading unit, and a control unit that adaptively switches reading of the plurality of viewpoint images by the image reading unit in the units of lines or in the units of pixels according to a scanning direction of a display unit and a base line length direction in the plurality of viewpoint images.

### BACKGROUND

The technology relates to an image processing apparatus, an image processing method, and a program capable of performing high-visibility parallax adjustment.

In the past, techniques of providing stereoscopic vision using parallax by combining a plurality of images acquired by capturing the same subject at different positions to generate a stereoscopic image, and stereoscopically displaying the generated stereoscopic image have been known. As a concrete technique of stereoscopic display, a stereoscopic image is generated such that a plurality of images are combined by overlapping a plurality of images while changing polarization directions thereof. In this case, stereoscopic vision can be provided by visually fusing stereoscopic images stereoscopically displayed using image separating glasses such as polarized glasses by an auto-focus function of the eyes.

Further, even when the polarized glasses or the like are not used, stereoscopic vision can be provided by displaying a plurality of images through a stereoscopic display monitor with a stereoscopic vision function as in a parallax barrier method. In this case, a plurality of images are clipped in rectangles and arranged alternately, a light blocking barrier with an opening is arranged, and a stereoscopic display is performed. Further, a technique of performing stereoscopic display based on a residual image effect by controlling light from a backlight in left and right-eye directions and causing a viewpoint image to be displayed on a display element in synchronization with the control by time division has been proposed (backlight control method).

When the stereoscopic vision is performed, a desirable stereoscopic effect differs according to a user who observes a stereoscopic image. Since the stereoscopic effect changes according to a deviation amount (parallax amount) of a plurality of stereoscopic images, in a technique disclosed in JP 2011-172286 A, a stereoscopic display of a stereoscopic image is switched to a two-dimensional (2D) display in which two images overlap according to a parallax amount change start instruction.

### SUMMARY

Meanwhile, in the technique disclosed in JP 2011-172286 A, switching between a left viewpoint image and a right viewpoint image is performed, and images of both viewpoints are viewed to overlap by the residual image effect. For this reason, when switching between the left viewpoint image and the right viewpoint image is not performed at a high speed, a sufficient residual image effect is not obtained, and it is difficult to perform 2D display with a high image quality. Further, in order to perform switching between the left viewpoint image and the right viewpoint image at a high speed, a configuration for increasing the speed of a circuit performing a display process is necessary, and thus it is difficult to reduce the cost.

It is desirable to providing an image processing apparatus, an image processing method, and a program, which are capable of easily performing high-visibility parallax adjustment.

According to an embodiment of the present disclosure, there is provided an image processing apparatus, including an image moving unit that moves viewpoint images according to an instruction from an outside, and changes a parallax amount among a plurality of viewpoint images, an image reading unit that reads the plurality of viewpoint images in units of lines or in units of pixels in a direction perpendicular to a line direction, an image selecting unit that sequentially selects and outputs the plurality of viewpoint images read in units of lines or in units of pixels by the image reading unit, and a control unit that adaptively switches reading of the plurality of viewpoint images by the image reading unit in the units of lines or in the units of pixels according to a scanning direction of a display unit and a base line length direction in the plurality of viewpoint images.

In the technology, a parallax amount among a plurality of viewpoint images is changed by moving viewpoint images according to an instruction from the outside. A planar image for parallax adjustment is generated such that the plurality of viewpoint images are read in units of lines or in units of pixels in a direction perpendicular to a line direction, and the plurality of viewpoint images read in units of lines or in units of pixels are sequentially selected. The reading of the plurality of viewpoint images is adaptively switched between units of lines and units of pixels according to a scanning direction of a display unit and a base line length direction (that corresponds to a direction connecting a left viewpoint with a right viewpoint when stereoscopic image display is performed based on a left viewpoint image and a right viewpoint image, for example) in a plurality of viewpoint images. For example, when an image is displayed in a state in which the scanning direction matches the base line length direction, the left viewpoint image and the right viewpoint image are read in units of lines, and when an image is displayed in a state in which the scanning direction is perpendicular to the base line length direction, the left viewpoint image and the right viewpoint image are read in units of pixels. An attitude detecting unit that detects an attitude status of a display unit is further provided, and it is determined whether an image is displayed in a state in which the scanning direction matches the base line length direction or an image is displayed in a state in which the scanning direction is perpendicular to the base line length direction, based on the attitude status detected by the attitude detecting unit. When a display unit that performs stereoscopic image display using the plurality of viewpoint images is provided, stereoscopic image display is suspended, and a planar image for parallax adjustment is displayed. Further, through movement of an image, the left viewpoint image and the right viewpoint image are moved in directions opposite to each other, the parallax amount is changed, and a mask process of a region that is generated by movement of the viewpoint images and that does not have an image is performed.

According to an embodiment of the present disclosure, there is provided an image processing method, including moving viewpoint images according to an instruction from an outside, and changing a parallax amount among a plurality of viewpoint images, reading the plurality of viewpoint images in units of lines or in units of pixels in a direction perpendicular to a line direction, sequentially selecting and outputting the plurality of viewpoint images read in units of lines or in units of pixels, and adaptively switching reading of the plurality of viewpoint images in the units of lines or in the units of pixels according to a scanning direction of a display unit and a base line length direction in the plurality of viewpoint images.

According to an embodiment of the present disclosure, there is provided a program for causing a computer to display an image for parallax amount adjustment, the program causing the computer to execute moving viewpoint images according to an instruction from an outside, and changing a parallax amount among a plurality of viewpoint images, reading the plurality of viewpoint images in units of lines or in units of pixels in a direction perpendicular to a line direction, sequentially selecting and outputting the plurality of viewpoint images read in units of lines or in units of pixels, and adaptively switching reading of the plurality of viewpoint images in the units of lines or in the units of pixels according to a scanning direction of a display unit and a base line length direction in the plurality of viewpoint images.

Note that the program of the present technology is a program that can be provided using a storage medium and a communication medium that is provided to a general-purpose computer that can execute various program codes in a computer-readable form, for example, a storage medium such as an optical disc, a magnetic disk, a semiconductor memory or a communication medium such as a network. By providing the program in the computer-readable form, a process according to the program is realized on a computer.

According to the technology, a parallax amount among a plurality of viewpoint images is changed by moving viewpoint images through an image moving unit according to an instruction from the outside. An image for parallax adjustment is generated such that an image reading unit reads a plurality of viewpoint images in units of lines or in units of pixels in a direction perpendicular to a line direction, and an image selecting unit sequentially selects and outputs the plurality of viewpoint images read in units of lines or in units of pixels. According to a scanning direction of a display unit and a base line length direction in a plurality of viewpoint images, a control unit adaptively switches reading of a plurality of viewpoint images by the image reading unit in units of lines or in units of pixels. Thus, a planar image for parallax adjustment in which images clipped from the viewpoint images in the base line length direction are sequentially selected and arranged in a line in a direction perpendicular to the base line length direction can be generated. In other words, since a planar image in which viewpoint images are arranged in units of lines (or units of two or more lines) is displayed as the image for parallax adjustment, the parallax amount can be simply checked through the planar image, and thus high-visibility parallax adjustment can be easily performed.

### BRIEF DESCRIPTION OF THE DRAWINGS

FIG. 1 is a diagram illustrating a configuration of a first embodiment;

FIG. 2 is a flowchart illustrating an operation of the first embodiment;

FIGS. 3(A) and 3(B) are diagrams illustrating a base line length direction and a scanning direction of a display unit in a first operation;

FIGS. 4(A) to 4(C) are diagrams for describing the first operation;

FIGS. 5(A) to 5(C) are diagrams for describing the first operation (an example of adjusting a parallax amount);

FIGS. 6(A) and 6(B) are diagrams illustrating a base line length direction and a scanning direction of a display unit in a second operation.

FIGS. 7(A) to 7(D) are diagrams for describing the second operation;

FIG. 8 is a diagram illustrating a configuration of a second embodiment;

FIG. 9 is a flowchart illustrating an operation of the second embodiment;

FIGS. 10(A) to 10(F) are diagrams for describing a first operation;

FIGS. 11(A) to 11(F) are diagrams for describing a second operation;

FIG. 12 is a diagram illustrating a configuration of a third embodiment;

FIGS. 13(A) to 13(F) are diagrams for describing an operation according to the third embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted. The description will proceed in the following order.

1. First embodiment

1-1. Configuration of first embodiment

1-2. Operation of first embodiment

2. Second embodiment

2-1. Configuration of second embodiment

2-2. Operation of second embodiment

3. Third embodiment

3-1. Configuration and operation of third embodiment

### 1. First Embodiment

### 1-1. Configuration of First Embodiment

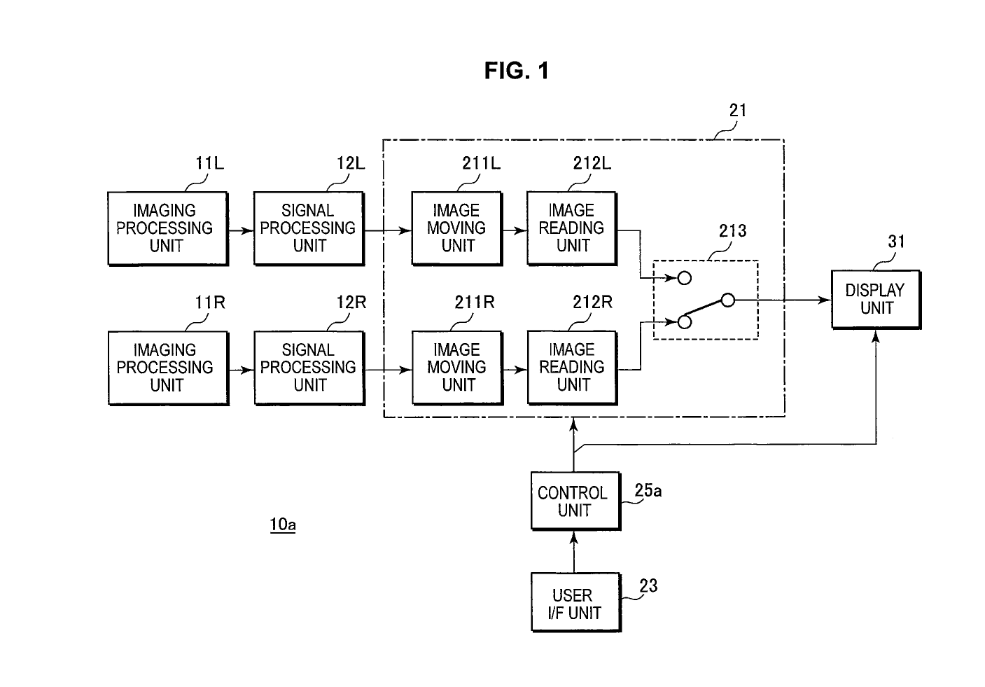

FIG. 1 illustrates a configuration of a first embodiment of the present technology. An electronic device 10a using an image processing apparatus according to a first embodiment includes imaging processing units 11L and 11R, signal processing units 12L and 12R, a display processing unit 21, a user interface (I/F) unit 23, a control unit 25a, and a display unit 31.

The imaging processing unit 11L includes an imaging optical system, an imaging element unit, or the like. A zoom lens, a focus lens, a diaphragm mechanism, and the like are disposed in the imaging optical system. The imaging optical system performs a focus adjusting operation to form a subject optical image of a left viewpoint on an imaging plane of an imaging element. Further, the imaging optical system performs an operation of changing a magnification of a subject optical image, an operation of adjusting a quantity of light, and the like. For example, a charge coupled device (CCD) image sensor, a complementary metal-oxide semiconductor (CMOS) image sensor, or the like is used as the imaging element. The imaging element performs a photoelectric conversion process, and converts an optical image formed on the imaging plane by the imaging optical system into an electric signal. The imaging processing unit 11L performs a noise removing process such as correlated double sampling (CDS) and gain adjustment of changing a signal level of the electric signal to a desired signal level on an electric signal generated by the imaging element. Further, the imaging processing unit 11L performs an analog-to-digital (A/D) converting process of converting an analog image signal, which is an electric signal that has been subjected to the noise removing process and the gain adjustment, into a digital image signal. The imaging processing unit 11L outputs the generated image signal of the left viewpoint to the signal processing unit 12L. The imaging processing unit 11R has the same configuration as the imaging processing unit 11L, generates an image signal of a right viewpoint image by the same operation as the imaging processing unit 11L, and outputs the generated image signal of the right viewpoint image to the signal processing unit 12R.

The signal processing unit 12L performs a camera process or the like on the image signal of the left viewpoint image output from the imaging processing unit 11L. For example, the signal processing unit 12L performs a non-linear process such as gamma correction or knee correction, a color correction process, a contour emphasizing process, and the like on the image signal, and then outputs the processed image signal to the display processing unit 21. The signal processing unit 12R has the same configuration as the signal processing unit 12L, performs the same process as the signal processing unit 12L on the image signal of the right viewpoint image output from the imaging processing unit 11R, and outputs the processed image signal to the display processing unit 21.

The display processing unit 21 includes image moving units 211L and 211R, image reading units 212L and 212R, and an image selecting unit 213.

The image moving unit 211L moves the left viewpoint image in a base line length direction based on a control signal from the control unit 25a which will be described later. The base line length direction refers a direction in which a left viewpoint is connected with a right viewpoint when stereoscopic image display is performed based on a left viewpoint image and a right viewpoint image, and an interval between the left viewpoint and the right viewpoint is referred to as a base line length. For example, the image moving unit 211L stores the image signal output from the signal processing unit 12L in a memory, controls a reading timing or a reading start position of the stored image signal, and generates a left viewpoint image moved in the base line length direction. The image moving unit 211L outputs the moved left viewpoint image to the image reading unit 212L. The image moving unit 211R has the same configuration as the image moving unit 211L. The image moving unit 211R moves the right viewpoint image in a base line length direction based on a control signal from the control unit 25a. The image moving unit 211R outputs the moved right viewpoint image to the image reading unit 212R. A moving direction of a right viewpoint image is opposite to a moving direction of a left viewpoint image. As described above, the image moving units 211L and 211R move the left viewpoint image and the right viewpoint image in the base line length direction in the opposite direction to each other, and change the parallax amount between the left viewpoint image and the right viewpoint image.

The image reading unit 212L reads an image from the moved left viewpoint image in units of lines or in units of pixels in a direction perpendicular to a line direction based on a control signal from the control unit 25a, and outputs the read image to the image selecting unit 213. The image reading unit 212R has the same configuration as the image reading unit 212L. The image reading unit 212R has the same configuration as the image reading unit 212L. The image reading unit 212R reads an image from the moved right viewpoint image in units of lines or in units of pixels in a direction perpendicular to a line direction based on a control signal from the control unit 25a, and outputs the read image to the image selecting unit 213.

The image selecting unit 213 sequentially selects the images output from the image reading units 212L and 212R based on a control signal from the control unit 25a, and generates a planar image in which the left viewpoint image and the right viewpoint image are alternately selected in units of lines or in units of pixels in a direction perpendicular to a line direction. The image selecting unit 213 outputs an image signal of the generated planar image to the display unit 31.

The user interface unit 23 includes an operation switch, a touch panel, and the like. The user interface unit 23 generates an operation signal according to the user's operation, and outputs the operation signal to the control unit 25a.

For example, the control unit 25a includes a central processing unit (CPU), a read only memory (ROM), and a random access memory (RAM). The CPU reads a control program stored in the ROM as necessary, and executes the control program. The ROM stores a program executed by the CPU, data necessary for various kinds of processes, and the like in advance. The RAM is a memory used as a work region in which an interim processing result or the like is temporarily stored. The ROM or the RAM stores information such as various kinds of setting parameters, correction data, and the like. The control unit 25a controls the respective components based on an operation signal from the user interface unit 23, and performs an operation according to the user's operation through the electronic device 10a.

When the user performs an operation of adjusting the parallax amount among a plurality of viewpoint images, the control unit 25a controls an operation of the display processing unit 21, arranges images clipped in the base line length direction from a plurality of viewpoint images in a line, and generates a planar image for parallax amount adjustment. The control unit 25a moves the viewpoint images through the image moving units 211L and 211R based on the operation signal from the user interface unit 23, and changes the parallax amount. Further, the control unit 25a adaptively switches reading of the viewpoint images in the image reading units 212L and 212R according to the scanning direction of the display unit 31 and the base line length direction in a plurality of viewpoint images in units of lines or units of pixels in a direction perpendicular to a line direction.

When the scanning direction of the display unit is caused to match the base line length direction and then a parallax adjustment image is displayed, the control unit 25a performs control such that the viewpoint images are read in units of lines through the image reading units 212L and 212R. Further, the control unit 25a controls the image selecting unit 213 such that outputs of the image reading unit 212L and the image reading unit 212R are alternately selected in units of lines, and generates a planar image for parallax amount adjustment. Further, when the line direction of the left viewpoint image and the right viewpoint image generated by the imaging processing units 11L and 11R matches the base line length direction in the left viewpoint image and the right viewpoint image, the planar image for parallax amount adjustment becomes an image in which images clipped in the base line length direction from the left viewpoint image and the right viewpoint image are alternately arranged in a line in a direction perpendicular to the base line length direction. In addition, when the scanning direction of the display unit is caused to be perpendicular to the base line length direction and then the image for parallax adjustment is displayed, the control unit 25a performs control such that the viewpoint images are read in units of pixels in a direction perpendicular to a line direction through the image reading units 212L and 212R. Further, the control unit 25a controls the image selecting unit 213 such that outputs of the image reading unit 212L and the image reading unit 212R are alternately selected in units of pixels, and generates the planar image for parallax amount adjustment. Further, when the line direction of the left viewpoint image and the right viewpoint image generated by the imaging processing units 11L and 11R matches the base line length direction in the left viewpoint image and the right viewpoint image, the planar image for parallax amount adjustment becomes an image in which images clipped in the base line length direction from the left viewpoint image and the right viewpoint image are alternately arranged in a line in a direction perpendicular to the base line length direction.

The display unit 31 includes a liquid crystal display (LCD) device, an organic EL display device, or the like. The display unit 31 displays the planar image for parallax amount adjustment on a screen based on the image signal output from the display processing unit 21. Further, when the display unit 31 has a stereoscopic image display function as well as a planar image display function, the display unit 31 suspends the stereoscopic image display function and displays the planar image based on the control signal from the control unit 25a when the parallax amount is adjusted. For example, when the display unit 31 has a function of displaying a stereoscopic image by the parallax barrier method, the parallax barrier is turned on based on the control signal from the control unit 25a. Further, when the display unit 31 has a function of displaying a stereoscopic image by the backlight control method, on/off control of the backlight is suspended, and an on state is set based on the control signal from the control unit 25a.

Further, when a stereoscopic image display is performed by the electronic device 10a, the image signal of the left viewpoint image output from the image moving unit 211L and the image signal of the right viewpoint image output from the image moving unit 211R are output to the display unit 31 as a signal of a predetermined format of a stereoscopic image.

### 1-2. Operation of First Embodiment

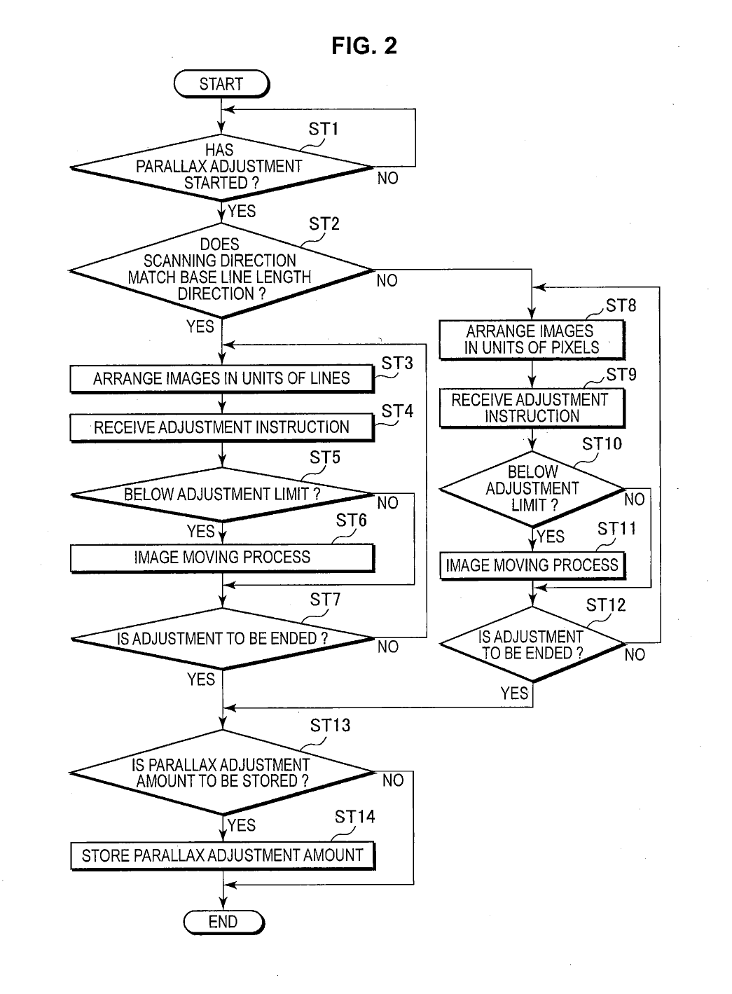

FIG. 2 is a flowchart illustrating an operation of the first embodiment. In step ST1, the control unit 25a determines whether or not parallax adjustment is to start. When it is determined that the parallax adjustment start operation has been performed based on the operation signal from the user interface unit 23, the control unit 25a causes the process to proceed to step ST2. However, when it is determined that the parallax adjustment start operation has not been performed, the control unit 25a causes the process to return to step ST1.

In step ST2, the control unit 25a determines whether or not the scanning direction matches the base line length direction. When it is determined that the scanning direction matches the base line length direction, the control unit 25a causes the process to proceed to step ST3. However, when it is determined that the scanning direction is perpendicular to the base line length direction, the control unit 25a causes the process to proceed to step ST8.

In step ST3, the control unit 25a causes images to be arranged in units of lines. The control unit 25a controls the image reading units 212L and 212R such that the viewpoint images are read in units of lines. In addition, the control unit 25a controls the image selecting unit 213, alternately selects outputs of the image reading unit 212L and the image reading unit 212R in units of lines, and generates the planar image for parallax amount adjustment, and then the process proceeds to step ST4.

In step ST4, the control unit 25a receives an adjustment instruction. The control unit 25a receives the adjustment instruction represented by the operation signal from the user interface unit 23, and then causes the process to proceed to step ST5.

In step ST5, the control unit 25a determines whether or not an adjustment limit has been reached. When it is determined that the viewpoint image has not reached the position of the adjustment limit, the control unit 25a causes the process to proceed to step S6. However, when it is determined that the viewpoint image has reached the position of the adjustment limit, the control unit 25a causes the process to proceed to step S7.

In step ST6, the control unit 25a performs an image moving process. The control unit 25a controls the image moving units 211L and 211R based on the received adjustment instruction, moves the image signals of the viewpoint images according to the adjustment instruction, and changes the parallax amount between the viewpoint images, and then the process proceeds to step ST7.

In step ST7, the control unit 25a determines whether or not the adjustment is to end. When it is determined that the parallax adjustment end operation has been performed based on the operation signal from the user interface unit 23, the control unit 25a causes the process to proceed to step ST13. However, when it is determined that the parallax adjustment end operation has not been performed, the process returns to step ST3.

In step ST8, the control unit 25a arranges images in units of pixels. The control unit 25a controls the image reading units 212L and 212R such that the viewpoint images are read in units of pixels. Further, the control unit 25a controls the image selecting unit 213, alternately selects outputs of the image reading unit 212L and the image reading unit 212R in units of pixels, and generates the planar image for parallax amount adjustment, and then the process proceeds to step ST9.

In step ST9, the control unit 25a receives an adjustment instruction. The control unit 25a receives the adjustment instruction represented by the operation signal from the user interface unit 23, and then causes the process to proceed to step ST10.

In step ST10, the control unit 25a determines whether or not an adjustment limit has been reached. When it is determined that the viewpoint image has not reached the position of the adjustment limit, the control unit 25a causes the process to proceed to step S11. However, when it is determined that the viewpoint image has reached the position of the adjustment limit, the control unit 25a causes the process to proceed to step S12.

In step ST11, the control unit 25a performs an image moving process. The control unit 25a controls the image moving units 211L and 211R based on the received adjustment instruction, moves the image signals of the viewpoint images according to the adjustment instruction, and changes the parallax amount between the viewpoint images, and then the process proceeds to step ST12.

In step ST12, the control unit 25a determines whether or not the adjustment is to end. When it is determined that the parallax adjustment end operation has been performed based on the operation signal from the user interface unit 23, the control unit 25a causes the process to proceed to step ST13. However, when it is determined that the parallax adjustment end operation has not been performed, the process returns to step ST8.

In step ST13, the control unit 25a determines whether or not the parallax adjustment amount is to be stored. When it is determined that an instruction for storing the parallax adjustment amount is given based on the operation signal from the user interface unit 23 or when the operation of the electronic device 10a is set to store the parallax adjustment amount, the control unit 25a causes the process to proceed to step ST14. However, when it is determined that an instruction for storing the parallax adjustment amount is not given based on the operation signal from the user interface unit 23 or when the operation of the electronic device 10a is set not to store the parallax adjustment amount, the control unit 25a ends the parallax adjustment operation.

In step ST14, the control unit 25a stores the parallax adjustment amount. For example, when the image signals of the viewpoint images that have been subjected to the parallax adjustment are used as a signal of a predetermined format of a stereoscopic image, the control unit 25a includes the parallax adjustment amount in header information of the predetermined format, and then ends the parallax adjustment operation.

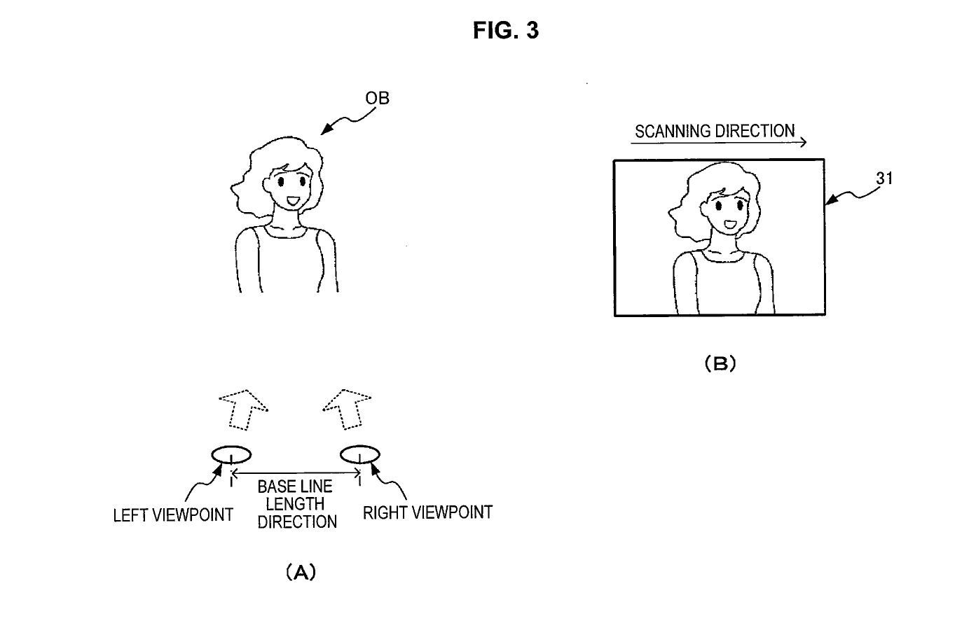

Next, an example in which the base line length direction matches the scanning direction of the display unit will be described as a first operation according to the first embodiment. FIGS. 3(A) and 3(B) illustrate the base line length direction and the scanning direction of the display unit in the first operation. For example, as illustrated in FIG. 3(A), when a subject OB is captured from positions of left and right viewpoints arranged in the horizontal direction to generate a left viewpoint image and a right viewpoint image, the base line length direction connecting the left viewpoint with the right viewpoint is the horizontal direction. In the first operation, as illustrated in FIG. 3(B), the scanning direction of the display unit 31 is the horizontal direction, and the planar image for parallax adjustment is displayed by the display unit 31.

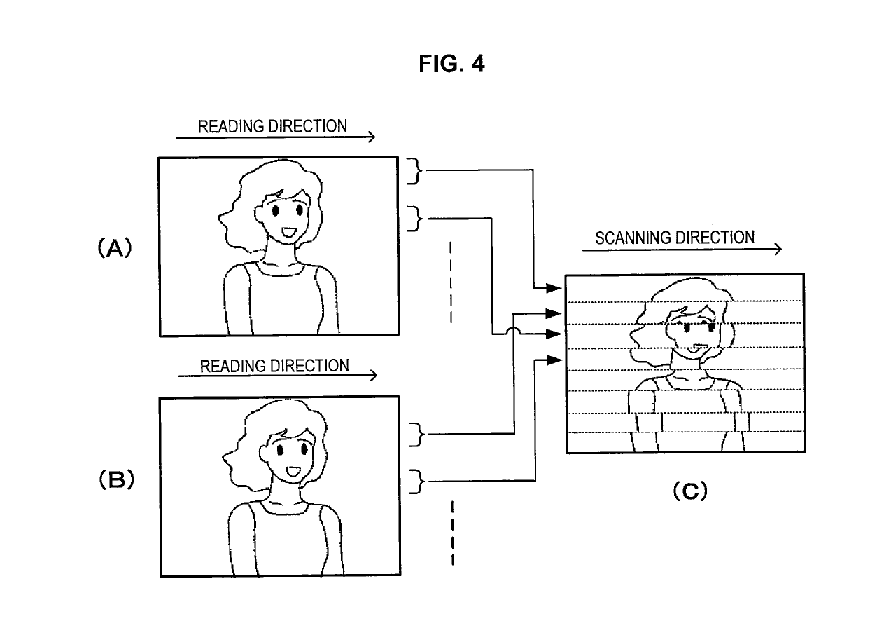

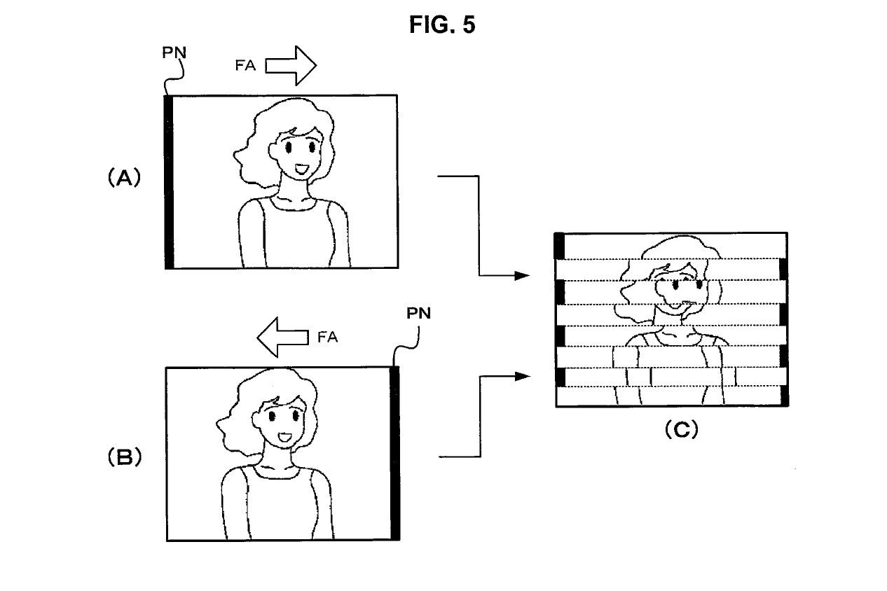

FIGS. 4(A) to 5(C) are diagrams for describing the first operation according to the first embodiment. FIG. 4(A) illustrates a left viewpoint image, and FIG. 4(B) illustrates a right viewpoint image. The image reading unit 212L reads the left viewpoint image in units of lines, and outputs the read left viewpoint image to the image selecting unit 213. Further, the image reading unit 212R reads the right viewpoint image in units of lines, and outputs the read right viewpoint image to the image selecting unit 213. The image selecting unit 213 alternately selects the left viewpoint image and the right viewpoint image output in units of lines to generate an image signal of a planar image. Thus, as illustrated in FIG. 4(C), the planar image for parallax amount adjustment based on the generated image signal becomes an image in which images clipped from the left viewpoint image and the right viewpoint image in the base line length direction are alternately arranged in a line in a direction perpendicular to the base line length direction. In other words, the planar image in which viewpoint images are arranged in a line in units of lines (or units of two or more lines) is obtained.

In order to adjust the parallax amount, the left viewpoint image illustrated in FIG. 5(A) and the right viewpoint image illustrated in FIG. 5(B) are moved based on the adjustment instruction in directions opposite to each other in the base line length direction. For example, in order to increase the parallax amount, the viewpoint images are moved in directions represented by arrows FA. In this case, the planar image illustrated in FIG. 5(C) is obtained. Further, when the viewpoint images are moved, a region PN having no image occurs. Thus, in the planar image, for example, the region having no image is displayed in black by a mask process. In addition, when the viewpoint images are directionally moved according to the adjustment instruction, if the amount of movement is twice as large as the image size in the horizontal direction (corresponding to the base line direction), a region where the left viewpoint image overlaps the right viewpoint image disappears. Thus, the adjustment limit amount is assumed to be twice the image size in the horizontal direction (corresponding to the base line direction) or less.

As described above, in the first operation according to the first embodiment, valid data of the viewpoint image is moved according to the adjustment instruction in horizontal synchronization to generate the planar image for parallax amount adjustment. Further, when there is an adjustment limit, valid data of the viewpoint image is moved up to the adjustment limit position within the horizontal synchronization to generate the planar image for parallax amount adjustment.

Next, an example in which the base line length direction is perpendicular to the scanning direction of the display unit, for example, an example in which landscape display using a long side as the horizontal direction is performed using a display unit for portrait display using a short side as the horizontal direction will be described as a second operation according to the first embodiment.

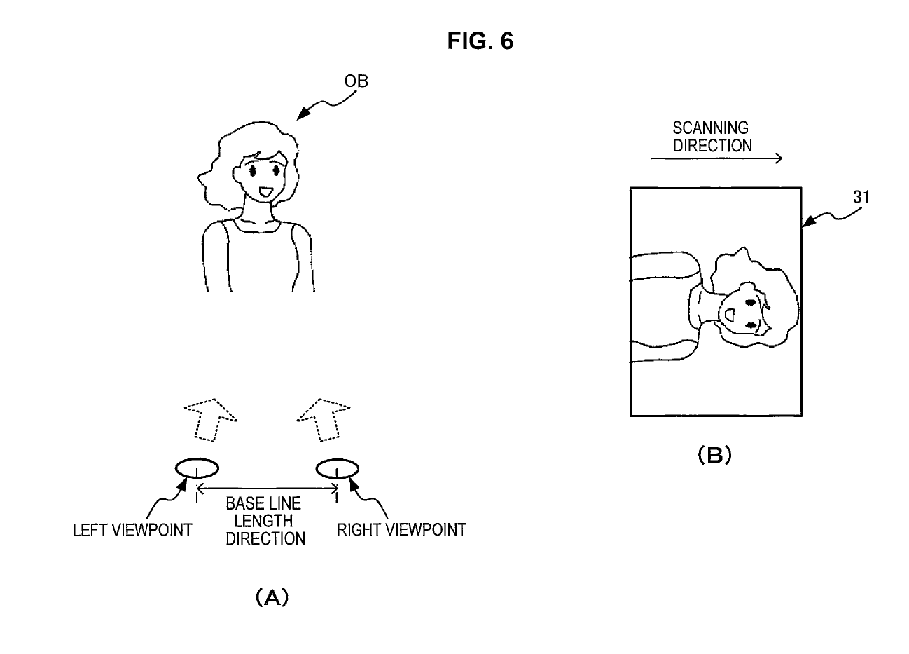

FIGS. 6(A) and 6(B) illustrate the base line length direction and the scanning direction of the display unit in the second operation. For example, as illustrated in FIG. 6(A), when a subject OB is captured from positions of left and right viewpoints arranged in the horizontal direction to generate a left viewpoint image and a right viewpoint image, the base line length direction connecting the left viewpoint with the right viewpoint is the horizontal direction. In the second operation, as illustrated in FIG. 6(B), the scanning direction of the display unit 31 is a direction perpendicular to a display image, and the planar image for parallax adjustment is displayed by the display unit 31.

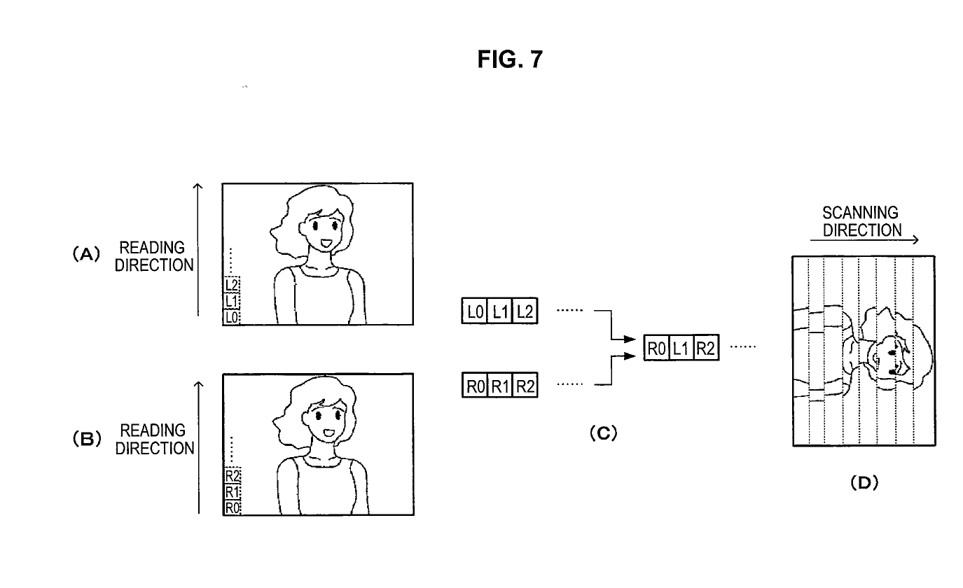

FIGS. 7(A) to 7(D) are diagrams for describing the second operation according to the first embodiment. FIG. 7(A) illustrates a left viewpoint image, and FIG. 7(B) illustrates a right viewpoint image. The image reading unit 212L reads the left viewpoint image in units of pixels in a direction perpendicular to a line direction (for example, in the order of pixels L0, L1, L2, and the like), and outputs the read left viewpoint image to the image selecting unit 213. Further, the image reading unit 212R reads the right viewpoint image in units of pixels in a direction perpendicular to a line direction (for example, in the order of pixels R0, R1, R2, and the like), and outputs the read right viewpoint image to the image selecting unit 213. As illustrated in FIG. 7(C), the image selecting unit 213 alternately selects the left viewpoint image and the right viewpoint image output in units of pixels (for example, in the order of the pixels R0, L1, R2, and the like), and generates the image signal of the planar image. As illustrated in FIG. 7(D), the planar image for parallax amount adjustment based on the generated image signal becomes an image in which images clipped from the left viewpoint image and the right viewpoint image in the base line length direction are alternately arranged in a line in a direction perpendicular to the base line length direction. In other words, the planar image in which viewpoint images are arranged in a line in units of lines (or units of two or more lines) is obtained.

As described above, in the second operation according to the first embodiment, valid data of the viewpoint image is moved according to the adjustment instruction within vertical synchronization to generate the planar image for parallax amount adjustment. Further, when there is an adjustment limit, valid data of the viewpoint image is moved up to the adjustment limit position within the vertical synchronization to generate the planar image for parallax amount adjustment.

Thus, according to the first embodiment, a plurality of viewpoint images can be combined without performing a calculation process such as multiplication, addition, or the like, and thus an image processing apparatus having a simple configuration can be provided at a low cost. Further, even when the base line length direction matches or is perpendicular to the scanning direction of the display unit, it is possible to generate the planar image in which images clipped from each of a plurality of viewpoint images in the base line length direction are sequentially arranged in a line in a direction perpendicular to the base line length direction. In other words, because the planar image in which the viewpoint images are arranged in units of lines (or in units of two or more lines) is displayed as the image for parallax adjustment, a high-visibility parallax adjustment function can be provided. Further, since it is unnecessary to perform the parallax adjustment while viewing the stereoscopic image having the deviated parallax, a burden on the eyes can be reduced.

### 2. Second Embodiment

Meanwhile, the first embodiment has been described in connection with the example in which the planar image for parallax amount adjustment is generated according to the scanning direction of the display unit. However, when the electronic device is portable, a change of the display unit changes according to a change in attitude of the electronic device. In this case, it is difficult to display a display image in a proper direction unless the direction of the display image is changed according to a change in the direction of the display unit. In this regard, a second embodiment will be described in connection with an example in which the planar image for parallax amount adjustment is generated in view of the attitude of the electronic device.

### 2-1. Configuration of Second Embodiment

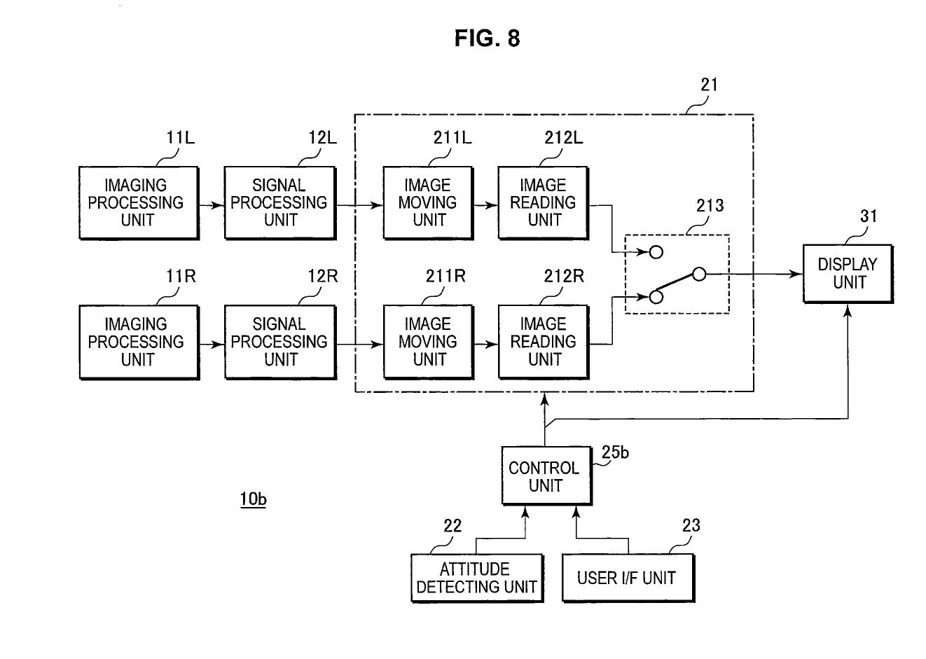

FIG. 8 illustrates a configuration of the second embodiment of the present technology. An electronic device 10b using an image processing apparatus according to the second embodiment includes imaging processing units 11L and 11R, signal processing units 12L and 12R, a display processing unit 21, an attitude detecting unit 22, a user interface (I/F) unit 23, a control unit 25b, and a display unit 31.

The imaging processing unit 11L includes an imaging optical system, an imaging element unit, or the like. A zoom lens, a focus lens, a diaphragm mechanism, and the like are disposed in the imaging optical system. The imaging optical system performs a focus adjusting operation to form a subject optical image of a left viewpoint on an imaging plane of an imaging element. Further, the imaging optical system performs an operation of changing a magnification of a subject optical image, an operation of adjusting a quantity of light, and the like. For example, a charge coupled device (CCD) image sensor, a complementary metal-oxide semiconductor (CMOS) image sensor, or the like is used as the imaging element. The imaging element performs a photoelectric conversion process, and converts an optical image formed on the imaging plane by the imaging optical system into an electric signal. The imaging processing unit 11L performs a noise removing process such as correlated double sampling (CDS) and gain adjustment of changing a signal level of the electric signal to a desired signal level on an electric signal generated by the imaging element. Further, the imaging processing unit 11L performs an analog-to-digital (A/D) converting process of converting an analog image signal, which is an electric signal that has been subjected to the noise removing process and the gain adjustment, into a digital image signal. The imaging processing unit 11L outputs the generated image signal of the left viewpoint to the signal processing unit 12L. The imaging processing unit 11R has the same configuration as the imaging processing unit 11L, generates an image signal of a right viewpoint image by the same operation as the imaging processing unit 11L, and outputs the generated image signal of the right viewpoint image to the signal processing unit 12R.

The signal processing unit 12L performs a camera process or the like on the image signal of the left viewpoint image output from the imaging processing unit 11L. For example, the signal processing unit 12L performs a non-linear process such as gamma correction or knee correction, a color correction process, a contour emphasizing process, and the like on the image signal, and then outputs the processed image signal to the display processing unit 21. The signal processing unit 12R has the same configuration as the signal processing unit 12L, performs the same process as the signal processing unit 12L on the image signal of the right viewpoint image output from the imaging processing unit 11R, and outputs the processed image signal to the display processing unit 21.

The display processing unit 21 includes image moving units 211L and 211R, image reading units 212L and 212R, and an image selecting unit 213.

The image moving unit 211L moves the left viewpoint image in the base line length direction based on a control signal from the control unit 25b which will be described later. For example, the image moving unit 211L stores the image signal output from the signal processing unit 12L in a memory, controls a reading timing or a reading start position of the stored image signal, and generates a left viewpoint image moved in the base line length direction. The image moving unit 211L outputs the moved left viewpoint image to the image reading unit 212L. The image moving unit 211R has the same configuration as the image moving unit 211L. The image moving unit 211R moves the right viewpoint image in base line length direction based on a control signal from the control unit 25b. The image moving unit 211R outputs the moved right viewpoint image to the image reading unit 212R. A moving direction of a right viewpoint image is opposite to a moving direction of a left viewpoint image. As described above, the image moving units 211L and 211R move the left viewpoint image and the right viewpoint image in the base line length direction in the opposite direction to each other, and change the parallax amount between the left viewpoint image and the right viewpoint image.

The image reading unit 212L reads an image from the moved left viewpoint image in units of lines or in units of pixels in a direction perpendicular to a line direction based on a control signal from the control unit 25b, and outputs the read image to the image selecting unit 213. The image reading unit 212R has the same configuration as the image reading unit 212L. The image reading unit 212R reads an image from the moved right viewpoint image in units of lines or in units of pixels in a direction perpendicular to a line direction based on a control signal from the control unit 25b, and outputs the read image to the image selecting unit 213.

The image selecting unit 213 sequentially selects the images output from the image reading units 212L and 212R based on a control signal from the control unit 25b, and generates a planar image in which the left viewpoint image and the right viewpoint image are alternately selected in units of lines or in units of pixels in a direction perpendicular to a line direction. The image selecting unit 213 outputs an image signal of the generated planar image to the display unit 31.

The attitude detecting unit 22 includes an inclination sensor or the like. The attitude detecting unit 22 detects the attitude of the electronic device 10b, for example, detects whether the electronic device 10b stands horizontally or vertically, and outputs a detection signal representing a detection result to the control unit 25b.

The user interface unit 23 includes an operation switch, a touch panel, and the like. The user interface unit 23 generates an operation signal according to the user's operation, and outputs the operation signal to the control unit 25b.

For example, the control unit 25b includes a CPU, a ROM, and a RAM. The CPU reads a control program stored in the ROM as necessary, and executes the control program. The ROM stores a program executed by the CPU, data necessary for various kinds of processes, and the like in advance. The RAM is a memory used as a work region in which an interim processing result or the like is temporarily stored. The ROM or the RAM stores information such as various kinds of setting parameters, correction data, and the like. The control unit 25b controls the respective components based on an operation signal from the user interface unit 23, and performs an operation according to the user's operation through the electronic device 10b.

When the user performs an operation of adjusting the parallax amount among a plurality of viewpoint images, the control unit 25b controls an operation of the display processing unit 21, arranges images clipped in the base line length direction (a horizontal direction of a visual contact) from a plurality of viewpoint images in a line, and generates a planar image for parallax amount adjustment. The control unit 25b moves the viewpoint images through the image moving units 211L and 211R based on the operation signal from the user interface unit 23, and changes the parallax amount.

The control unit 25b adaptively switches reading of the viewpoint images in the image reading units 212L and 212R according to the scanning direction of the display unit 31 and the base line length direction in a plurality of viewpoint images in units of lines or units of pixels in a direction perpendicular to a line direction. In addition, the control unit 25b determines whether or not an image is displayed in a state in which the scanning direction matches the base line length direction or an image is displayed in a state in which the scanning direction is perpendicular to the base line length direction or an image, based on the attitude status of the electronic device 10b detected by the attitude detecting unit 22.

When the scanning direction of the display unit is caused to match the base line length direction and then a parallax adjustment image is displayed, the control unit 25b performs control such that the viewpoint images are read in units of lines through the image reading units 212L and 212R. Further, the control unit 25b controls the image selecting unit 213 such that outputs of the image reading unit 212L and the image reading unit 212R are alternately selected in units of lines, and generates a planar image for parallax amount adjustment. Further, when the line direction of the left viewpoint image and the right viewpoint image generated by the imaging processing units 11L and 11R matches the base line length direction in the left viewpoint image and the right viewpoint image, the planar image for parallax amount adjustment becomes an image in which images clipped in the base line length direction from the left viewpoint image and the right viewpoint image are alternately arranged in a line in a direction perpendicular to the base line length direction. In addition, when the scanning direction of the display unit is caused to be perpendicular to the base line length direction and then the image for parallax adjustment is displayed, the control unit 25b performs control such that the viewpoint images are read in units of pixels in a direction perpendicular to a line direction through the image reading units 212L and 212R. Further, the control unit 25b controls the image selecting unit 213 such that outputs of the image reading unit 212L and the image reading unit 212R are alternately selected in units of pixels, and generates the planar image for parallax amount adjustment. Further, when the line direction of the left viewpoint image and the right viewpoint image generated by the imaging processing units 11L and 11R matches the base line length direction in the left viewpoint image and the right viewpoint image, the planar image for parallax amount adjustment becomes an image in which images clipped in the base line length direction from the left viewpoint image and the right viewpoint image are alternately arranged in a line in a direction perpendicular to the base line length direction.

The display unit 31 includes an LCD device, an organic EL display device, or the like. The display unit 31 displays the planar image for parallax amount adjustment on a screen based on the image signal output from the display processing unit 21. Further, when the display unit 31 has a stereoscopic image display function as well as a planar image display function, the display unit 31 suspends the stereoscopic image display function and displays the planar image based on the control signal from the control unit 25b when the parallax amount is adjusted.

Further, when stereoscopic image display is performed by the electronic device 10b, the image signal of the left viewpoint image output from the image moving unit 211L and the image signal of the right viewpoint image output from the image moving unit 211R are output to the display unit 31 as a signal of a predetermined format of a stereoscopic image.

### 2-2. Operation of Second Embodiment

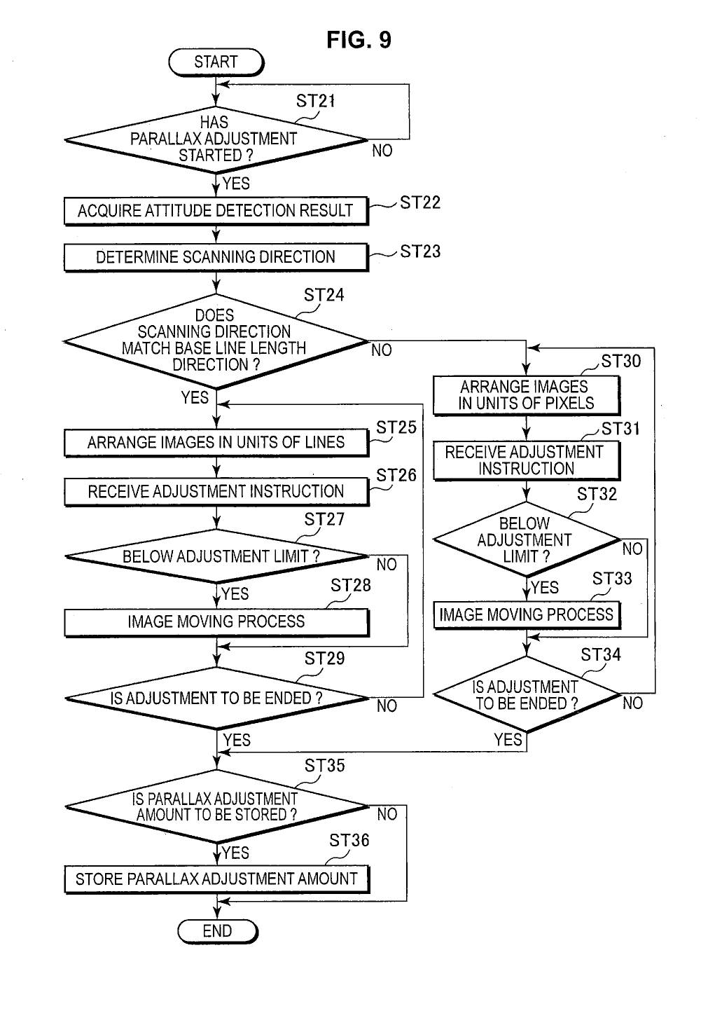

FIG. 9 is a flowchart illustrating an operation of the second embodiment. In step ST21, the control unit 25b determines whether or not parallax adjustment is to start. When it is determined that the parallax adjustment start operation has been performed based on the operation signal from the user interface unit 23, the control unit 25b causes the process to proceed to step ST22. However, when it is determined that the parallax adjustment start operation has not been performed, the control unit 25b causes the process to return to step ST21.

In step ST22, the control unit 25b acquires the attitude detection result. The control unit 25b acquires the detection signal from the attitude detecting unit 22, and then causes the process to proceed to step ST23.

In step ST23, the control unit 25b determines the scanning direction. For example, the control unit 25b determines whether the electronic device 10b stands horizontally or vertical based on the acquired detection signal, and determines a direction set as the scanning direction of the display unit 31 installed in the electronic device 10b, and then the process proceeds to step ST24.

In step ST24, the control unit 25b determines whether or not the scanning direction matches the base line length direction. When it is determined that the determined scanning direction of the display unit 31 matches the base line length direction of the viewpoint image, the control unit 25b causes the process to proceed to step ST25. However, when it is determined that the scanning direction is perpendicular to the base line length direction, the control unit 25b causes the process to proceed to step ST30.

In step ST25, the control unit 25b causes images to be arranged in units of lines. The control unit 25b controls the image reading units 212L and 212R such that the viewpoint images are read in units of lines. In addition, the control unit 25b controls the image selecting unit 213, alternately selects outputs of the image reading unit 212L and the image reading unit 212R in units of lines, and generates the planar image for parallax amount adjustment, and then the process proceeds to step ST26.

In step ST26, the control unit 25b receives an adjustment instruction. The control unit 25b receives the adjustment instruction represented by the operation signal from the user interface unit 23, and then causes the process to proceed to step ST27.

In step ST27, the control unit 25b determines whether or not an adjustment limit has been reached. When it is determined that the viewpoint image has not reached the position of the adjustment limit, the control unit 25b causes the process to proceed to step S28. However, when it is determined that the viewpoint image has reached the position of the adjustment limit, the control unit 25b causes the process to proceed to step S29.

In step ST28, the control unit 25b performs an image moving process. The control unit 25b controls the image moving units 211L and 211R based on the received adjustment instruction, moves the image signals of the viewpoint images according to the adjustment instruction, and changes the parallax amount between the viewpoint images, and then the process proceeds to step ST29.

In step ST29, the control unit 25b determines whether or not the adjustment is to end. When it is determined that the parallax adjustment end operation has been performed based on the operation signal from the user interface unit 23, the control unit 25a causes the process to proceed to step ST35. However, when it is determined the parallax adjustment end operation has not been performed, the process returns to step ST25.

In step ST30, the control unit 25b arranges images in units of pixels. The control unit 25b controls the image reading units 212L and 212R such that the viewpoint images are read in units of pixels. Further, the control unit 25b controls the image selecting unit 213, alternately selects outputs of the image reading unit 212L and the image reading unit 212R in units of pixels, and generates the planar image for parallax amount adjustment, and then the process proceeds to step ST41.

In step ST31, the control unit 25b receives an adjustment instruction. The control unit 25b receives the adjustment instruction represented by the operation signal from the user interface unit 23, and then causes the process to proceed to step ST32.

In step ST32, the control unit 25b determines whether or not an adjustment limit has been reached. When it is determined that the viewpoint image has not reached the position of the adjustment limit, the control unit 25b causes the process to proceed to step S33. However, when it is determined that the viewpoint image has reached the position of the adjustment limit, the control unit 25b causes the process to proceed to step S34.

In step ST33, the control unit 25b performs an image moving process. The control unit 25b controls the image moving units 211L and 211R based on the received adjustment instruction, moves the image signals of the viewpoint images according to the adjustment instruction, and changes the parallax amount between the viewpoint images, and then the process proceeds to step ST34. As described above, by moving the viewpoint images, the planar image for parallax amount adjustment in which valid data of the viewpoint image is moved according to the adjustment instruction within the vertical synchronization is generated.

In step ST34, the control unit 25b determines whether or not the adjustment is to end. When it is determined that the parallax adjustment end operation has been performed based on the operation signal from the user interface unit 23, the control unit 25b causes the process to proceed to step ST35. However, when it is determined that the parallax adjustment end operation has not been performed, the process returns to step ST30.

In step ST35, the control unit 25b determines whether or not the parallax adjustment amount is to be stored. When it is determined that an instruction for storing the parallax adjustment amount is given based on the operation signal from the user interface unit 23 or when the operation of the electronic device 10a is set to store the parallax adjustment amount, the control unit 25b causes the process to proceed to step ST36. However, when it is determined that an instruction for storing the parallax adjustment amount is not given based on the operation signal from the user interface unit 23 or when the operation of the electronic device 10a is set not to store the parallax adjustment amount, the control unit 25b ends the parallax adjustment operation.

In step ST36, the control unit 25b stores the parallax adjustment amount. For example, when the image signals of the viewpoint images that have been subjected to the parallax adjustment are used as a signal of a predetermined format of a stereoscopic image, the control unit 25b includes the parallax adjustment amount in header information of the predetermined format, and then ends the parallax adjustment operation.

Next, a first operation according to the second embodiment will be described. In the first operation, the scanning direction of the display unit 31 is a longitudinal direction of a display region, and when the electronic device 10b stands horizontally, the scanning direction is assumed to be the horizontal direction.

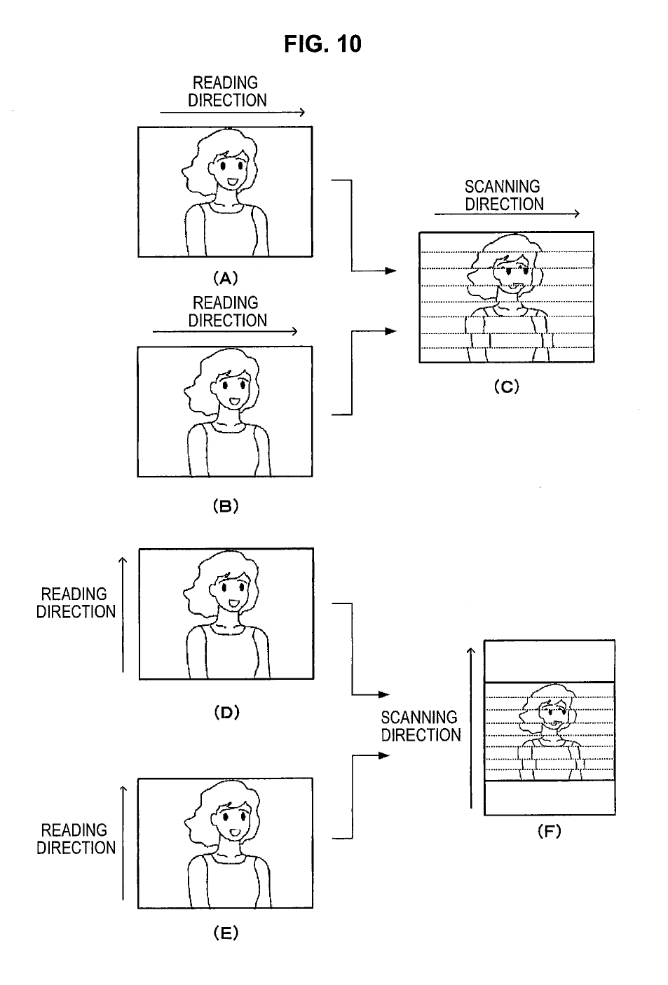

FIGS. 10(A) to 10(F) are diagrams for describing the first operation according to the second embodiment. The image reading units 212L and 212R switch the image reading direction according to the attitude detection result of the attitude detecting unit 22 based on the control signal from the control unit 25b. For example, when the electronic device 10b stands horizontally, and the scanning direction is the horizontal direction serving as the base line length direction, the image reading unit 212L reads the left viewpoint image in units of lines and outputs the read left viewpoint image to the image selecting unit 213 as illustrated in FIG. 10(A). Then, as illustrated in FIG. 10(B), the image reading unit 212R reads the right viewpoint image in units of lines, and outputs the read right viewpoint image to the image selecting unit 213. The image selecting unit 213 alternately selects the left viewpoint image and the right viewpoint image output in units of lines, and generates the planar image for parallax amount adjustment as illustrated in FIG. 10(C).

Further, for example, when the electronic device 10b stands vertically, and the scanning direction is perpendicular to the base line length direction, the image reading unit 212L reads the left viewpoint image in units of pixels, and outputs the read left viewpoint image to the image selecting unit 213 as illustrated in FIG. 10(D). Further, as illustrated in FIG. 10(E), the image reading unit 212R reads the right viewpoint image in units of pixels, and outputs the read right viewpoint image to the image selecting unit 213. The image selecting unit 213 alternately selects the left viewpoint image and the right viewpoint image output in units of pixels, and generates the planar image for parallax amount adjustment as illustrated in FIG. 10(F).

Next, a second operation according to the second embodiment will be described. In the second operation, the scanning direction of the display unit 31 is the short direction of the display region, and when the electronic device 10b stands horizontally, the scanning direction is the vertical direction.

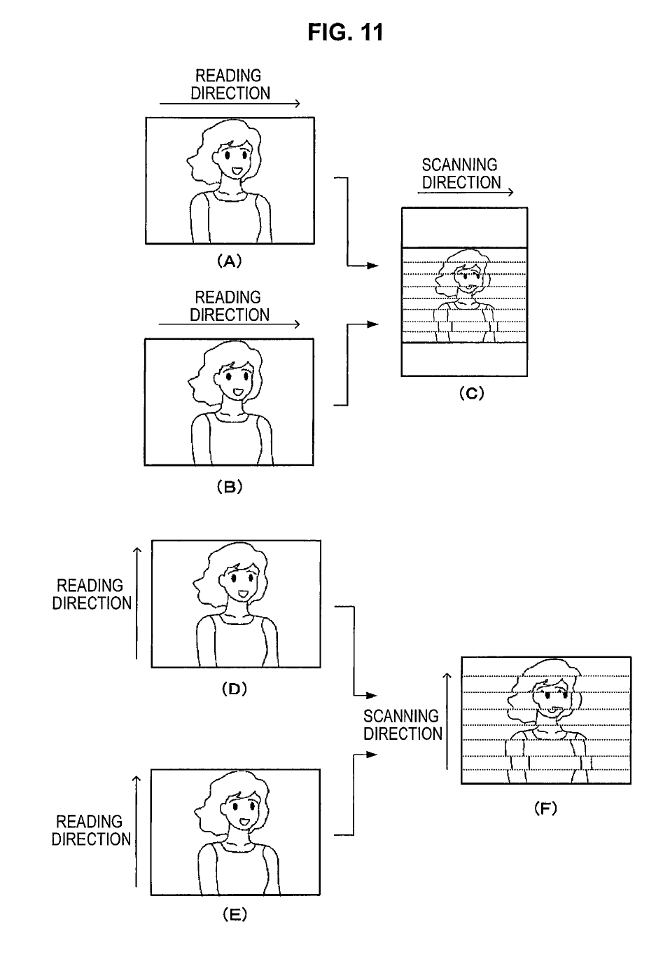

FIGS. 11(A) to 11(F) are diagrams for describing the second operation according to the second embodiment. The image reading units 212L and 212R switch the image reading direction according to the attitude detection result of the attitude detecting unit 22 based on the control signal from the control unit 25b. For example, when the electronic device 10b stands vertically, and the scanning direction is the horizontal direction serving as the base line length direction, the image reading unit 212L reads the left viewpoint image in units of lines and outputs the read left viewpoint image to the image selecting unit 213 as illustrated in FIG. 11(A). Then, as illustrated in FIG. 11(B), the image reading unit 212R reads the right viewpoint image in units of lines, and outputs the read right viewpoint image to the image selecting unit 213. The image selecting unit 213 alternately selects the left viewpoint image and the right viewpoint image output in units of lines, and generates the planar image for parallax amount adjustment as illustrated in FIG. 11(C).

Further, for example, when the electronic device 10b stands horizontally, and the scanning direction is perpendicular to the base line length direction, the image reading unit 212L reads the left viewpoint image in units of pixels, and outputs the read left viewpoint image to the image selecting unit 213 as illustrated in FIG. 11(D). Further, as illustrated in FIG. 11(E), the image reading unit 212R reads the right viewpoint image in units of pixels, and outputs the read right viewpoint image to the image selecting unit 213. The image selecting unit 213 alternately selects the left viewpoint image and the right viewpoint image output in units of pixels, and generates the planar image for parallax amount adjustment as illustrated in FIG. 11(F).

As described above, according to the second embodiment, similarly to the first embodiment, a plurality of viewpoint images can be combined without performing a calculation process such as a multiplication, an addition, or the like, and thus an image processing apparatus having a simple configuration can be provided at a low cost. Further, even when the base line length direction matches or is perpendicular to the scanning direction of the display unit, it is possible to generate the planar image in which images clipped from each of a plurality of viewpoint images in the base line length direction are sequentially arranged in a line in a direction perpendicular to the base line length direction. In other words, the planar image in which the viewpoint images are arranged in units of lines (or in units of two or more lines) is displayed as the image for parallax adjustment, a high-visibility parallax adjustment function can be provided.

In addition, in the second embodiment, the attitude detection is performed, and reading of the viewpoint image is switched based on the attitude detection result. Thus, the planar image for parallax amount adjustment can be displayed regardless of the direction of the display unit 31, and thus the high-visibility parallax adjustment function can be provided.

### 3. Third Embodiment

Meanwhile, in the first and second embodiments, when the scanning direction does not match the base line length direction, if the direction of reading the planar image stored in the memory is changed, an address calculation of a pixel to be read becomes complicated. Further, there are cases in which a read data unit is not necessarily limited to one pixel according to a system. In this regard, in the third embodiment, when the scanning direction does not match the base line length direction, the planar image is rotated such that the scanning direction matches the base line length direction, and an image is read in units of pixels from the rotated image.

### 3-1. Configuration and Operation of Third Embodiment

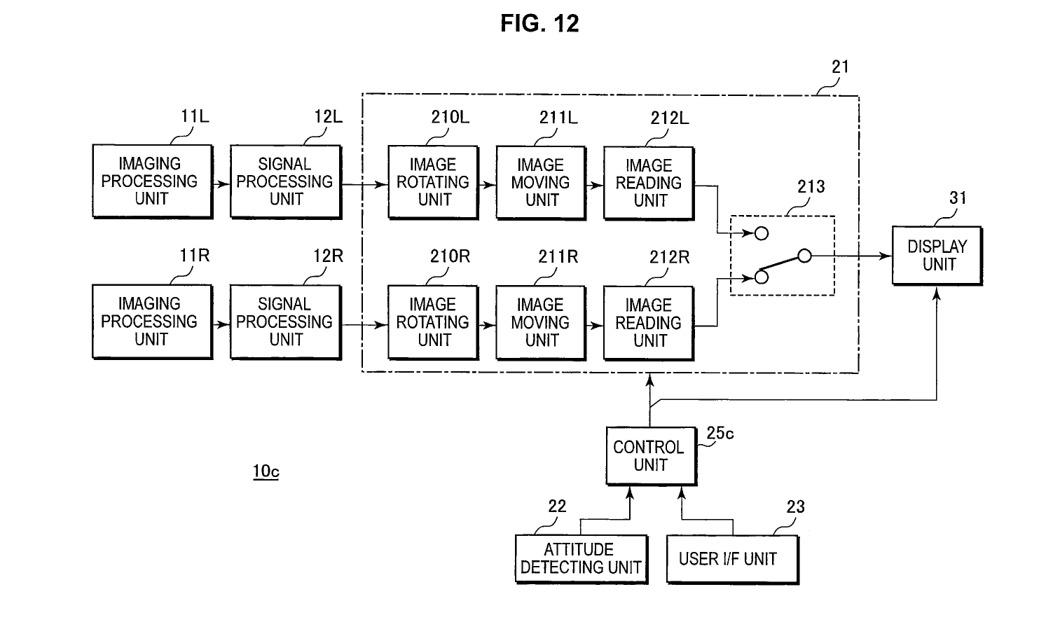

FIG. 12 illustrates a configuration of a third embodiment of the present technology. An electronic device 10c using an image processing apparatus according to the third embodiment includes imaging processing units 11L and 11R, signal processing units 12L and 12R, a display processing unit 21c, an attitude detecting unit 22, a user interface (I/F) unit 23, a control unit 25c, and a display unit 31.

The imaging processing unit 11L includes an imaging optical system, an imaging element unit, or the like. A zoom lens, a focus lens, a diaphragm mechanism, and the like are disposed in the imaging optical system. The imaging optical system performs a focus adjusting operation to form a subject optical image of a left viewpoint on an imaging plane of an imaging element. Further, the imaging optical system performs an operation of changing a magnification of a subject optical image, an operation of adjusting a quantity of light, and the like. For example, a charge coupled device (CCD) image sensor, a complementary metal-oxide semiconductor (CMOS) image sensor, or the like is used as the imaging element. The imaging element performs a photoelectric conversion process, and converts an optical image formed on the imaging plane by the imaging optical system into an electric signal. The imaging processing unit 11L performs a noise removing process such as correlated double sampling (CDS) and gain adjustment of changing a signal level of the electric signal to a desired signal level on an electric signal generated by the imaging element. Further, the imaging processing unit 11L performs an analog-to-digital (A/D) converting process of converting an analog image signal, which is an electric signal that has been subjected to the noise removing process and the gain adjustment, into a digital image signal. The imaging processing unit 11L outputs the generated image signal of the left viewpoint to the signal processing unit 12L. The imaging processing unit 11R has the same configuration as the imaging processing unit 11L, generates an image signal of a right viewpoint image by the same operation as the imaging processing unit 11L, and outputs the generated image signal of the right viewpoint image to the signal processing unit 12R.

The signal processing unit 12L performs a camera process or the like on the image signal of the left viewpoint image output from the imaging processing unit 11L. For example, the signal processing unit 12L performs a non-linear process such as gamma correction or knee correction, a color correction process, a contour emphasizing process, and the like on the image signal, and then outputs the processed image signal to the display processing unit 21. The signal processing unit 12R has the same configuration as the signal processing unit 12L, performs the same process as the signal processing unit 12L on the image signal of the right viewpoint image output from the imaging processing unit 11R, and outputs the processed image signal to the display processing unit 21.

The display processing unit 21c includes image rotating units 210L and 210R, image moving units 211L and 211R, image reading units 212L and 212R, and an image selecting unit 213.

The image rotating unit 210L rotates the left viewpoint image output from the signal processing unit 12L based on a control signal from the control unit 25c which will be described later. For example, when the scanning direction is perpendicular to the base line length direction, the image rotating unit 210L rotates the left viewpoint image 90 degrees clockwise, and outputs the rotated left viewpoint image to the image moving unit 211L. The image rotating unit 210R has a configuration similar to the image rotating unit 210L. The image rotating unit 210R rotates the left viewpoint image output from the signal processing unit 12R based on the control signal from the control unit 25c. For example, when the scanning direction is perpendicular to the base line length direction, similarly to the image rotating unit 210L, the image rotating unit 210R rotates the right viewpoint image clockwise at 90 degree, and outputs the rotated right viewpoint image to the image moving unit 211R.

The image moving unit 211L moves the left viewpoint image in the base line length direction based on the control signal from the control unit 25c which will be described later. For example, the image moving unit 211L stores the image signal output from the image rotating unit 210L in the memory, controls the reading timing or the reading start position of the stored image signal, and generates the left viewpoint image moved in the base line length direction. The image moving unit 211L outputs the moved left viewpoint image to the image reading unit 212L. The image moving unit 211R has the same configuration as the image moving unit 211L. The image moving unit 211R moves the right viewpoint image in the base line length direction based on the control signal from the control unit 25c. The image moving unit 211R outputs the moved right viewpoint image to the image reading unit 212R. A moving direction of a right viewpoint image is opposite to a moving direction of a left viewpoint image. As described above, the image moving units 211L and 211R move the left viewpoint image and the right viewpoint image in the base line length direction in the opposite direction to each other, and change the parallax amount between the left viewpoint image and the right viewpoint image.

The image reading unit 212L reads an image from the moved left viewpoint image in units of lines or in units of pixels in a direction perpendicular to a line direction based on a control signal from the control unit 25c, and outputs the read image to the image selecting unit 213. The image reading unit 212R has the same configuration as the image reading unit 212L. The image reading unit 212R reads an image from the moved right viewpoint image in units of lines or in units of pixels in a direction perpendicular to a line direction based on a control signal from the control unit 25c, and outputs the read image to the image selecting unit 213.

The image selecting unit 213 sequentially selects the images output from the image reading units 212L and 212R based on a control signal from the control unit 25a, and generates a planar image in which the left viewpoint image and the right viewpoint image are alternately selected in units of lines or in units of pixels in a line direction. The image selecting unit 213 outputs an image signal of the generated planar image to the display unit 31.

The attitude detecting unit 22 includes an inclination sensor or the like. The attitude detecting unit 22 detects the attitude of the electronic device 10bc, for example, detects whether the electronic device 10c stands horizontally or vertically, and outputs a detection signal representing a detection result to the control unit 25c.

The user interface unit 23 includes an operation switch, a touch panel, and the like. The user interface unit 23 generates an operation signal according to the user's operation, and outputs the operation signal to the control unit 25c.

For example, the control unit 25c includes a CPU, a ROM, and a RAM. The CPU reads a control program stored in the ROM as necessary, and executes the control program. The ROM stores a program executed by the CPU, data necessary for various kinds of processes, and the like in advance. The RAM is a memory used as a work region in which an interim processing result or the like is temporarily stored. The ROM or the RAM stores information such as various kinds of setting parameters, correction data, and the like. The control unit 25c controls the respective components based on an operation signal from the user interface unit 23, and performs an operation according to the user's operation through the electronic device 10c.

When the user performs an operation of adjusting the parallax amount among a plurality of viewpoint images, the control unit 25c controls an operation of the display processing unit 21, arranges images clipped in the base line length direction from a plurality of viewpoint images in a line, and generates a planar image for parallax amount adjustment. Further, the control unit 25c moves the viewpoint images through the image moving units 211L and 211R based on the operation signal from the user interface unit 23, and changes the parallax amount.

The control unit 25c determines whether or not an image is displayed in a state in which the scanning direction matches the base line length direction or an image is displayed in a state in which the scanning direction is perpendicular to the base line length direction or an image, based on the attitude status of the electronic device 10c detected by the attitude detecting unit 22.

When the scanning direction of the display unit is caused to match the base line length direction and then a parallax adjustment image is displayed, the control unit 25c performs control such that the viewpoint images are read in units of lines through the image reading units 212L and 212R. Further, the control unit 25c controls the image selecting unit 213 such that outputs of the image reading unit 212L and the image reading unit 212R are alternately selected in units of lines, and generates a planar image for parallax amount adjustment.

Further, when the scanning direction of the display unit is caused to be perpendicular to the base line length direction and then the image for parallax adjustment is displayed, for example, the control unit 25c rotates the viewpoint image 90 degrees through the image rotating units 210L and 210R. Further, the control unit 25c performs control such that the viewpoint image is read in units of pixels in the line direction through the image reading units 212L and 212R. The control unit 25c controls the image selecting unit 213 such that outputs of the image reading unit 212L and the image reading unit 212R are alternately selected in units of pixels, and generates the planar image for parallax amount adjustment.

The display unit 31 includes an LCD device, an organic EL display device, or the like. The display unit 31 displays the planar image for parallax amount adjustment on a screen based on the image signal output from the display processing unit 21. Further, when the display unit 31 has a stereoscopic image display function as well as a planar image display function, the display unit 31 suspends the stereoscopic image display function and displays the planar image based on the control signal from the control unit 25c when the parallax amount is adjusted.

Further, when stereoscopic image display is performed by the electronic device 10c, the image signal of the left viewpoint image output from the image moving unit 211L and the image signal of the right viewpoint image output from the image moving unit 211R are output to the display unit 31 as a signal of a predetermined format of a stereoscopic image.

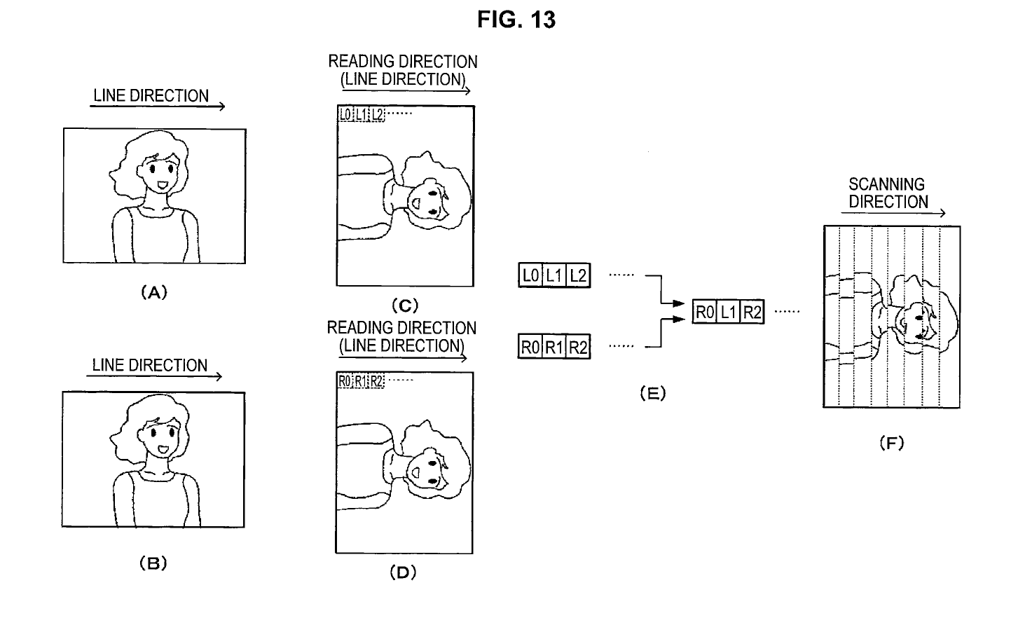

FIGS. 13(A) to 13(B) are diagrams for describing an operation according to the third embodiment. FIG. 13(A) illustrates a left viewpoint image, and FIG. 13(B) illustrates a right viewpoint image. For example, when the scanning direction is perpendicular to the base line length direction, the electronic device 10c rotates the left viewpoint image and the right viewpoint image 90 degrees clockwise. FIG. 13(C) illustrates the rotated left viewpoint image, and FIG. 13(D) illustrates the rotated right viewpoint image. Thus, when images are arranged in units of pixels, reading of the rotated left viewpoint image in units of pixels (for example, in the order of pixels L0, L1, L2, and the like) and reading of the rotated right viewpoint image in units of pixels (for example, in the order of pixels R0, R1, R2, and the like) are performed in the line direction. As illustrated in FIG. 13(E), the image selecting unit 213 alternately selects the left viewpoint image and the right viewpoint image output in units of pixels (for example, in the order of the pixels R0, L1, R2, and the like), and generates an image of a planar image. As illustrated in FIG. 13(F), the planar image for parallax amount adjustment based on the generated image signal becomes an image in which images clipped from the left viewpoint image and the right viewpoint image in the base line length direction are alternately arranged in a line in a direction perpendicular to the base line length direction. In other words, the planar image in which viewpoint images are arranged in a line in units of lines (or units of two or more lines) is obtained.

As described above, when the scanning direction does not match the base line length direction, the planar image is rotated such that the scanning direction matches the base line length direction, and when the rotated image is read in units of pixels, the pixel data is read in the line direction, and thus the pixel data can be easily read. The third embodiment has been described in connection with the configuration in which an image is rotated and then moved, but an image may be moved and then rotated.

Further, the first and third embodiments have been described in connection with the example in which the image moving units 211L and 211R, the image reading units 212L and 212R, and the image selecting unit 213 are provided as the functional configuration of the display processing unit 21. However, the display processing unit 21 may not individually perform the operations of the image moving units 211L and 211R, the image reading units 212L and 212R, and the image selecting unit 213, but may collectively perform the operations thereof. For example, the left viewpoint image and the image signal of the right viewpoint image output from the signal processing unit are stored in the memory, an image to be read from the memory is selected, the reading timing, the reading start position, and the reading direction of the selected image are controlled, and the image signal of the planar image for parallax adjustment is generated. In this case, the configuration of the display processing unit 21 may be simplified.

Further, in the first to third embodiments, units of lines are not limited to units of single lines and may be units of two or more lines. Further, units of pixels are not limited to units of single pixels and may be units of two or more pixels. For example, when a component signal of a 4:2:2 format is processed, since there is a lack of color in one pixel, processing is performed in units of two pixels. Further, interpolation of a color difference component may be performed on a component signal of a 4:2:2 format to be converted into a component signal of a 4:4:4 format, and processing may be performed in units of single pixels.

Furthermore, the processing sequence that is explained in the specification can be implemented by hardware, by software and by a configuration that combines hardware and software. In a case where the processing is implemented by software, it is possible to install in memory within a computer that is incorporated into dedicated hardware a program in which the processing sequence is encoded and to execute the program. It is also possible to install a program in a general-purpose computer that is capable of performing various types of processing and to execute the program.

For example, the program can be recorded on a hard disk or ROM (Read Only Memory) as a recording medium in advance. Alternatively, the program can be temporarily or permanently stored (recorded) in (on) a removable recording medium such as a flexible disk, CD-ROM (Compact Disc Read Only Memory), MO (Magneto Optical) disk, DVD (Digital Versatile Disc), a magnetic disk, or a semiconductor memory card. Such a removable recording medium can be provided as so-called package software. In addition, the program can be, not only installed on a computer from a removable recording medium, but also transferred wirelessly or by wire to the computer from a download site via a network such as a LAN (Local Area Network) or the Internet. In such a computer, a program transferred in the aforementioned manner can be received and installed on a recording medium such as built-in hardware.

The present technology is not interpreted to be limited to the above embodiments. The embodiments of the technology disclose the present technology by the exemplary embodiments, and it is obvious to those skilled in the art that the embodiments can be modified or substituted within a range not departing from the gist of the present technology. In other words, the gist of the present technology should be determined by claims set forth as follows.

Additionally, the present technology may also be configured as below.

(1) An image processing apparatus, including:

an image moving unit that moves viewpoint images according to an instruction from an outside, and changes a parallax amount among a plurality of viewpoint images;

an image reading unit that reads the plurality of viewpoint images in units of lines or in units of pixels in a direction perpendicular to a line direction;

an image selecting unit that sequentially selects and outputs the plurality of viewpoint images read in units of lines or in units of pixels by the image reading unit; and

a control unit that adaptively switches reading of the plurality of viewpoint images by the image reading unit in the units of lines or in the units of pixels according to a scanning direction of a display unit and a base line length direction in the plurality of viewpoint images.

(2) The image processing apparatus according to (1),

wherein, when an image is displayed in a state in which the scanning direction matches the base line length direction, the control unit causes the image reading unit to perform the reading in units of lines, and when an image is displayed in a state in which the scanning direction is perpendicular to the base line length direction, the control unit causes the image reading unit to perform the reading in units of pixels.

(3) The image processing apparatus according to (2), further including

an attitude detecting unit that detects an attitude status of a display unit,

wherein the control unit determines whether an image is displayed in a state in which the scanning direction matches the base line length direction or an image is displayed in a state in which the scanning direction is perpendicular to the base line length direction, based on the attitude status detected by the attitude detecting unit.

(4) The image processing apparatus according to (2) or (3), further including

an image rotating unit that rotates the plurality of viewpoint images,

wherein, when an image is displayed in a state in which the scanning direction is perpendicular to the base line length direction, the control unit causes the image rotating unit to rotate the plurality of viewpoint images such that the base line length direction in the plurality of viewpoint images matches the scanning direction, and performs the reading in units of pixels by the image reading unit in the line direction.

(5) The image processing apparatus according to any one of (1) to (4), further including

a display unit that performs stereoscopic image display by using the plurality of viewpoint images,

wherein the control unit suspends stereoscopic image display on the display unit, and displays a planar image based on an output from the image selecting unit.

(6) The image processing apparatus according to any one of (1) to (5),

wherein the image moving unit performs a mask process of a region that is generated by movement of the viewpoint images and that does not have an image.

(7) The image processing apparatus according to any one of (1) to (6),

wherein the plurality of viewpoint images are a left viewpoint image and a right viewpoint image, and

wherein the image moving unit moves the left viewpoint image and the right viewpoint image in directions opposite to each other, and changes a parallax amount.

In the image processing apparatus, the image processing method, and the program according to the technology, a parallax amount among a plurality of viewpoint images is changed by moving viewpoint images through an image moving unit according to an instruction from the outside. An image for parallax adjustment is generated such that an image reading unit reads the plurality of viewpoint images in units of lines or in units of pixels in a direction perpendicular to a line direction, and an image selecting unit sequentially selects and outputs the plurality of viewpoint images in units of lines or in units of pixels. According to a scanning direction of a display unit and a base line length direction in a plurality of viewpoint images, reading of a plurality of viewpoint images is adaptively switched in units of lines or in units of pixels. Thus, since a planar image for parallax adjustment in which images clipped from the viewpoint images in the base line length direction are sequentially selected and arranged in a line in a direction perpendicular to the base line length direction can be generated, the parallax amount can be simply checked through the planar image, and thus high-visibility parallax adjustment can be easily performed. Thus, the present technology is appropriate to adjustment of parallax amount when stereoscopic display is performed by a portable electronic device or the like.

The present disclosure contains subject matter related to that disclosed in Japanese Priority Patent Application JP 2012-143160 filed in the Japan Patent Office on Jun. 26, 2012 the entire content of which is hereby incorporated by reference.

What is claimed is:

1. An image processing apparatus, comprising:
an image moving unit that moves viewpoint images according to an instruction from an outside, and changes a parallax amount among a plurality of viewpoint images;
an image reading unit that reads the plurality of viewpoint images in units of lines or in units of pixels in a direction perpendicular to a line direction;
an image selecting unit that sequentially selects and outputs the plurality of viewpoint images read in units of lines or in units of pixels by the image reading unit; and
a control unit that adaptively switches reading of the plurality of viewpoint images by the image reading unit in the units of lines or in the units of pixels according to a scanning direction of a display unit and a base line length direction in the plurality of viewpoint images.

2. The image processing apparatus according to claim 1,
wherein, when an image is displayed in a state in which the scanning direction matches the base line length direction, the control unit causes the image reading unit to perform the reading in units of lines, and when an image is displayed in a state in which the scanning direction is perpendicular to the base line length direction, the control unit causes the image reading unit to perform the reading in units of pixels.

3. The image processing apparatus according to claim 2, further comprising
an attitude detecting unit that detects an attitude status of a display unit,
wherein the control unit determines whether an image is displayed in a state in which the scanning direction matches the base line length direction or an image is displayed in a state in which the scanning direction is perpendicular to the base line length direction, based on the attitude status detected by the attitude detecting unit.

4. The image processing apparatus according to claim 2, further comprising
an image rotating unit that rotates the plurality of viewpoint images,
wherein, when an image is displayed in a state in which the scanning direction is perpendicular to the base line length direction, the control unit causes the image rotating unit to rotate the plurality of viewpoint images such that the base line length direction in the plurality of viewpoint images matches the scanning direction, and performs the reading in units of pixels by the image reading unit in the line direction.

5. The image processing apparatus according to claim 1, further comprising
a display unit that performs stereoscopic image display by using the plurality of viewpoint images,
wherein the control unit suspends stereoscopic image display on the display unit, and displays a planar image based on an output from the image selecting unit.

6. The image processing apparatus according to claim 1,
wherein the image moving unit performs a mask process of a region that is generated by movement of the viewpoint images and that does not have an image.

7. The image processing apparatus according to claim 1,
wherein the plurality of viewpoint images are a left viewpoint image and a right viewpoint image, and
wherein the image moving unit moves the left viewpoint image and the right viewpoint image in directions opposite to each other, and changes a parallax amount.

8. An image processing method, comprising:
moving viewpoint images according to an instruction from an outside, and changing a parallax amount among a plurality of viewpoint images;
reading the plurality of viewpoint images in units of lines or in units of pixels in a direction perpendicular to a line direction;
sequentially selecting and outputting the plurality of viewpoint images read in units of lines or in units of pixels; and
adaptively switching reading of the plurality of viewpoint images in the units of lines or in the units of pixels according to a scanning direction of a display unit and a base line length direction in the plurality of viewpoint images.

9. A program for causing a computer to display an image for parallax amount adjustment, the program causing the computer to execute:
moving viewpoint images according to an instruction from an outside, and changing a parallax amount among a plurality of viewpoint images;
reading the plurality of viewpoint images in units of lines or in units of pixels in a direction perpendicular to a line direction;
sequentially selecting and outputting the plurality of viewpoint images read in units of lines or in units of pixels; and
adaptively switching reading of the plurality of viewpoint images in the units of lines or in the units of pixels according to a scanning direction of a display unit and a base line length direction in the plurality of viewpoint images.
